(19) United States
(12) Patent Application Publication
(10) Pub. No.: US 2010/0115441 A1
(43) Pub. Date: May 6, 2010

(54) METHOD AND APPARATUS FOR SCHEDULE SETTING IN PORTABLE TERMINAL

(75) Inventor: Min-Soo LEE, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/578,208

(22) Filed: Oct. 13, 2009

(30) Foreign Application Priority Data
Nov. 4, 2008 (KR) 10-2008-0108861

(51) Int. Cl. G06F 3/048; G06F 3/033

(52) U.S. Cl. 715/769; 715/863; 715/846

(57) ABSTRACT

An apparatus and method for schedule setting in a portable terminal are provided. The apparatus includes a touch manager for determining whether a drag execution is performed for schedule setting a schedule type, a controller for performing the schedule setting on a date for schedule setting, and a schedule setting unit for setting a schedule when the touch manager detects overlapping of the date with a schedule setting icon.

### PRIORITY

This application claims the benefit under 35 U.S.C. §119(a) of a Korean patent application filed in the Korean Intellectual Property Office on Nov. 4, 2008 and assigned Serial No. 10-2008-0108861, the entire disclosure of which is hereby incorporated by reference.

### BACKGROUND OF THE INVENTION

1. Field of the Invention

The present invention relates to an apparatus and method for schedule management of a portable terminal. More particularly, the present invention relates to an apparatus and method for setting a schedule in a touch type portable terminal without a plurality of key inputs.

2. Description of the Related Art

Portable terminals have become necessities of modern life for people of all ages. Thus, service providers and terminal manufacturers are competitively developing differentiated products or services.

For example, portable terminals have developed into a multimedia device capable of providing various services, such as phonebooks, games, short messages, e-mails, wake-up calls, Moving Picture Experts Group (MPEG)-1 Audio Layer 3 (MP3) players, schedule management, digital cameras and wireless Internet services.

A user of the portable terminal can use the schedule management by inputting a menu selection key of the portable terminal several times. That is, an additional key input (e.g., a key input for date selection) is required to use the scheduling management.

More particularly, since a recently released touch-input type portable terminal does not have an additional key input device, a plurality of touch inputs are required to display a schedule setting screen. Accordingly, the schedule setting screen and a detailed information input screen (i.e., a screen for inputting a title, a date, a start time, and the like) are displayed several times.

When the user of the portable terminal uses the aforementioned method for schedule setting, a specific screen is repetitively displayed to input a setup value of each item, which causes inconvenience to the user.

Therefore, a need exists for an apparatus and method for schedule setting of a touch-input type portable terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for enabling prompt schedule setting in a portable terminal.

Another aspect of the present invention is to provide an apparatus and method for enabling prompt schedule setting by using a drag mechanism in a portable terminal.

Still another aspect of the present invention is to provide an apparatus and method for performing schedule setting by clicking a date for which a schedule is set in a portable terminal.

In accordance with an aspect of the present invention, an apparatus for schedule setting in a portable terminal is provided. The apparatus includes a touch manager for determining whether a drag execution is performed for schedule setting by a schedule type, a controller for performing the schedule setting on a date selected for schedule setting, and a schedule setting unit for setting a schedule when the touch manager detects overlapping of the date with a schedule setting icon.

In accordance with another aspect of the present invention, a method for schedule setting in a portable terminal is provided. The method includes determining whether a drag execution is performed for schedule setting by a schedule type, performing the schedule setting on a date selected for schedule setting, and setting a schedule when the date overlaps with a schedule setting icon.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a structure of a portable terminal for performing a schedule setting process according to an exemplary embodiment of the present invention;

FIG. 2 is a flowchart illustrating a schedule setting process of a portable terminal according to an exemplary embodiment of the present invention;

FIG. 3 is a flowchart illustrating a schedule setting process of a portable terminal according to an exemplary embodiment of the present invention;

FIG. 4A illustrates a screen for setting a schedule by dragging a date for which the schedule is to be set in a portable terminal according to an exemplary embodiment of the present invention;

FIG. 4B illustrates a screen for setting a schedule by dragging a schedule setting icon in a portable terminal according to an exemplary embodiment of the present invention;

FIG. 4C illustrates a screen for setting a schedule by using a drag mechanism in a portable terminal according to an exemplary embodiment of the present invention;

FIG. 4D illustrates a screen displayed after schedule setting is complete in a portable terminal according to an exemplary embodiment of the present invention;

FIG. 5A illustrates a screen for setting a schedule by dragging a date for which the schedule is to be set in a portable terminal according to an exemplary embodiment of the present invention;

FIG. 5B illustrates a screen for setting a schedule by using a drag mechanism in a portable terminal according to an exemplary embodiment of the present invention;

FIG. 5C illustrates a screen for setting a schedule by using a drag mechanism in a portable terminal according to an exemplary embodiment of the present invention;

FIG. 6A illustrates a screen for clicking or touching a date for which a schedule is to be set in a portable terminal according to an exemplary embodiment of the present invention; and

FIG. 6B illustrates a screen showing a schedule setting icon used to set a schedule on a date in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Hereinafter, exemplary embodiments of the present invention provide an apparatus and method for setting a schedule that overcome the need to use a plurality of key inputs in a touch type portable terminal, without an additional input device.

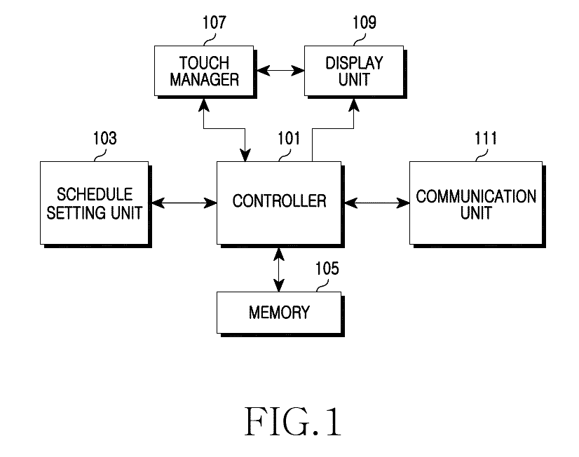

FIG. 1 is a block diagram illustrating a structure of a portable terminal for performing a schedule setting process according to an exemplary embodiment of the present invention.

Referring to FIG. 1, the portable terminal includes a controller 101, a schedule setting unit 103, a memory 105, a touch manager 107, a display unit 109 and a communication unit 111.

The controller 101 provides overall control to the portable terminal. For example, the controller 101 controls and processes voice communication and data communication. In an exemplary implementation, and as explained in more detail below, when a drag is made for schedule setting by overlapping a schedule setting icon with a date for which a schedule is set, the controller 101 allows the schedule setting process to be performed on the date for schedule setting.

That is, upon detecting a drag which overlaps the schedule setting icon with the date for schedule setting or upon detecting a drag which overlaps the date for schedule setting with the schedule setting icon, the controller 101 outputs a schedule setting screen to perform the schedule setting process.

In addition, upon detecting a click or touch on the date for schedule setting, the controller 101 outputs the schedule setting icon around the date to perform the schedule setting process.

In this case, the controller 101 may output a schedule setting bar in the schedule setting process to set a schedule setting time (e.g., a schedule start time and a schedule end time) by detecting movement of the bar.

The schedule setting unit 103 performs the schedule setting process under the instruction of the controller 101.

That is, under the instruction of the controller 101, the schedule setting unit 103 sets and manages a schedule time by detecting movement of the schedule setting bar currently being output.

In addition, upon detecting a click or touch on the date for schedule setting under the instruction of the controller 101, the schedule setting unit 103 outputs the schedule setting icon around the date to set a schedule.

The memory 105 includes a Read Only Memory (ROM), a Random Access Memory (RAM), a flash ROM, and the like. The ROM stores a microcode of a program for processing and control of the controller 101, the schedule setting unit 103 and a variety of reference data.

The RAM serves as a working memory of the controller 101 and may store temporary data that is generated while programs are performed. The flash ROM may store rewritable data, such as phonebook entries, outgoing messages, incoming messages, and the like.

The display unit 109 displays information, such as state information, which is generated while the portable terminal operates, limited numeral characters, large-sized moving and still pictures, and the like. The display unit 109 may be a color Liquid Crystal Display (LCD). The display unit 109 may include a touch input element to be used as an input device for a touch-input type portable terminal.

The communication unit 111 transmits and receives a Radio Frequency (RF) signal of data that is input and output through an antenna (not illustrated). For example, in a transmitting process, data to be transmitted is subject to a channel-coding process and a spreading process, and then the data is transformed to an RF signal. In a receiving process, the RF signal is received and transformed to a base-band signal. The base-band signal is subject to a de-spreading process and a channel-decoding process, thereby restoring the data.

Although a function of the schedule setting unit 103 may be performed by the controller 101 of the portable terminal, the schedule setting unit 103 and the controller 101 are separately constructed for exemplary purposes only. Thus, various modifications may be made without departing from the scope of the present invention. For example, functions of the schedule setting unit 103 and the controller 101 may be integrally configured to be processed by the controller 101.

A schedule setting apparatus for performing schedule setting in a touch type portable terminal without using a plurality of key inputs has been described above. In the following description, a schedule setting method for performing schedule setting in a touch type portable terminal using the aforementioned apparatus will be described below.

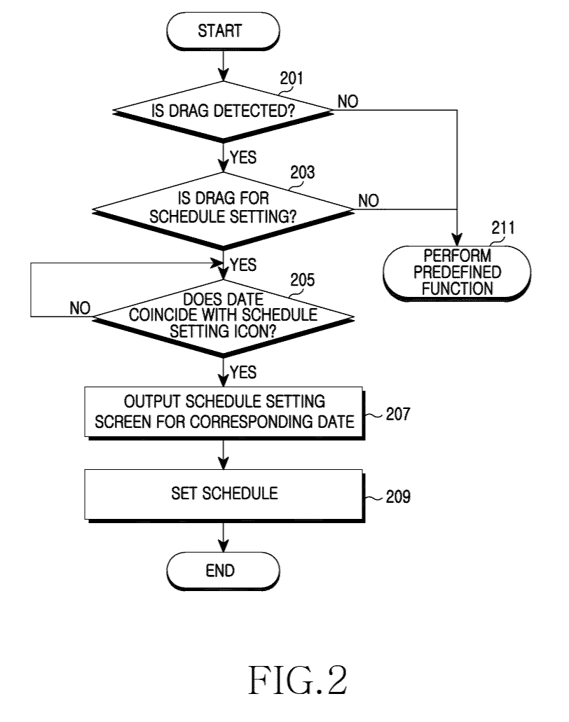

FIG. 2 is a flowchart illustrating a schedule setting process of a portable terminal according to an exemplary embodiment of the present invention.

Referring to FIG. 2, the portable terminal determines whether a drag is detected in step 201.

If the drag is not detected in step 201, the portable terminal performs a predefined function (e.g., a standby mode) in step 211.

In contrast, if the drag is detected in step 201, the portable terminal determines whether the detected drag is for schedule setting in step 203.

Herein, a drag for schedule setting implies that a drag is made to set a schedule by using a date and an icon for indicating a schedule type, which are currently being displayed on the portable terminal. The drag is made on the date or the icon. That is, the drag for schedule setting may be a drag on a date for which a schedule is set or a drag on an icon for the schedule.

If the determination result of step 203 shows that the drag is not for schedule setting, the portable terminal allows a predefined function (e.g., an operation corresponding to the drag, and the like) to be performed in step 211.

In contrast, if the determination result of step 203 shows that the drag is for schedule setting, the portable terminal determines whether the date for which the schedule is set coincides with the icon for the schedule in step 205. Coincidence of the date and the icon implies that the date is dragged onto the icon to overlap the date and the icon, or on the contrary, the icon is dragged onto the date to overlap the icon and the date. In an exemplary implementation, a schedule setting inconvenience due to the use of a plurality of key inputs may be solved by allowing the schedule to be set by dragging the icon or the date.

If the date for schedule setting and the schedule setting icon do not coincide in step 205, step 205 is repeated.

In contrast, if the date for schedule setting and the schedule setting icon coincide with each other in step 205, the portable terminal outputs a scheduling setting screen to set a schedule on the date in step 207, and performs a process for setting the schedule on the date for schedule setting in step 209.

Thereafter, the process ends.

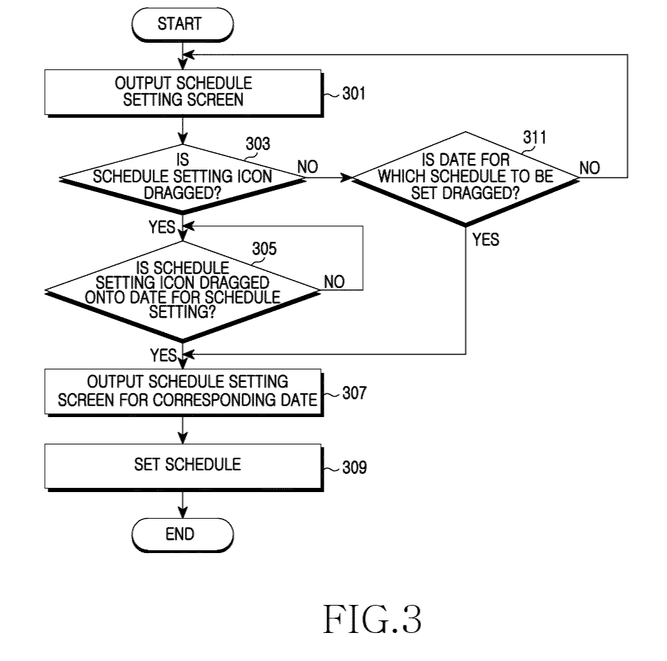

FIG. 3 is a flowchart illustrating a schedule setting process of a portable terminal according to an exemplary embodiment of the present invention.

Referring to FIG. 3, the portable terminal outputs a schedule setting screen in step 301. The schedule setting screen may be a calendar including a date for which a schedule may be set.

In step 303, the portable terminal determines whether a schedule setting icon is dragged. The schedule setting icon may include an icon in which a title of a corresponding schedule is illustrated in an iconic picture. The schedule setting icon may include a birthday icon, a journey icon, a work icon, an anniversary icon, and the like. A user of the portable terminal may edit (e.g., add, delete, and the like) the schedule setting icon.

If the determination result of step 303 shows that the schedule setting icon is dragged, the portable terminal determines whether the schedule setting icon is dragged onto a date for schedule setting in step 305.

If the determination result of step 305 shows that the schedule setting icon is dragged onto the date for schedule setting, the portable terminal outputs a schedule setting screen to set a schedule on the date in step 307.

If the determination result of step 303 shows that the schedule setting icon is not dragged, the portable terminal determines whether a date for which a schedule to be set is dragged in step 311. If it is determined that the date for schedule setting is dragged, the portable terminal proceeds to step 307.

That is, the portable terminal may set the schedule by dragging the schedule setting icon or the date for schedule setting.

The portable terminal outputs the schedule setting screen in step 307, and performs a schedule setting process on the date for schedule setting in step 309.

Thereafter, the procedure ends.

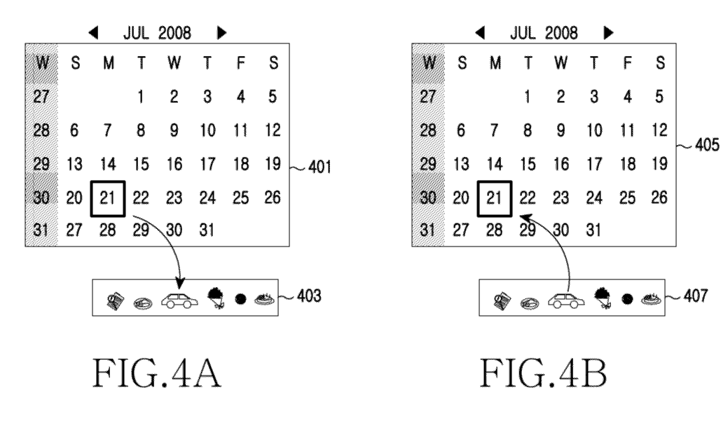

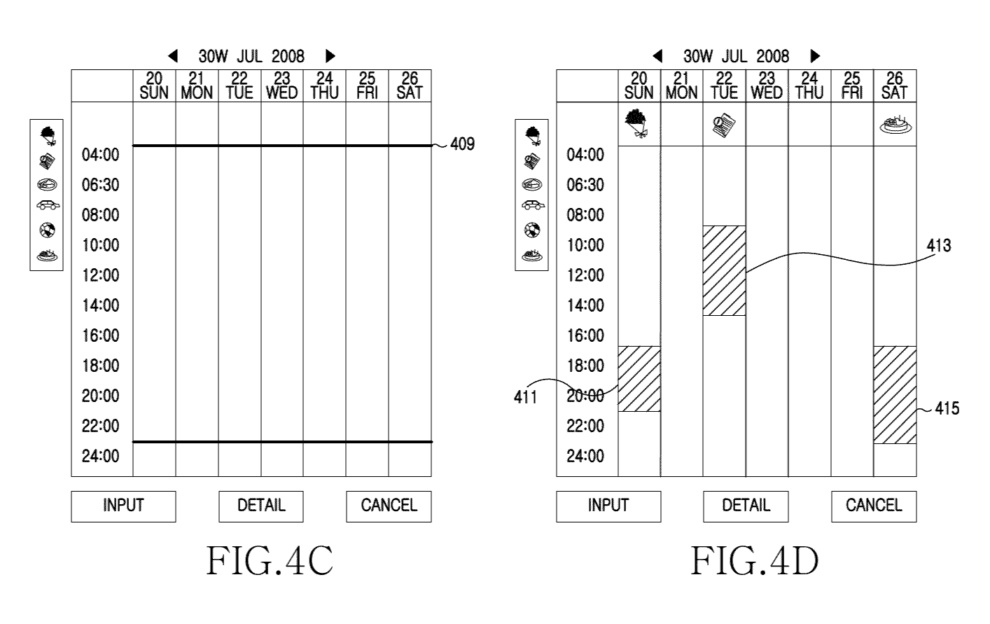

FIGS. 4A-4D illustrate a schedule setting screen of a portable terminal according to an exemplary embodiment of the present invention.

In an exemplary implementation, the portable terminal of FIG. 4 may perform a schedule setting process by simply dragging a date and an icon, instead of performing a schedule setting in a conventional portable terminal through a plurality of menu inputs.

FIG. 4A illustrates a screen for setting a schedule by dragging a date for which the schedule is to be set in a portable terminal according to an exemplary embodiment of the present invention.

Referring to FIG. 4A, a user of the portable terminal intends to set a schedule for a journey on Jul. 21, 2008 on a calendar 401. The user of the portable terminal may drag the date of 21 onto a schedule setting icon 403, and thereafter may set a journey schedule for the date of the 21^{st}.

FIG. 4B illustrates a screen for setting a schedule by dragging a schedule setting icon in a portable terminal according to an exemplary embodiment of the present invention.

Referring to FIG. 4B, a user of the portable terminal intends to set a schedule for a journey on Jul. 21, 2008 on a calendar 405 similarly to FIG. 4A. The user of the portable terminal performs schedule setting by dragging a schedule setting icon 407 for indicating a journey onto the date of the 21^{st}.

FIG. 4C illustrates a screen for setting a schedule by using a drag mechanism in a portable terminal according to an exemplary embodiment of the present invention.

Referring to FIG. 4C, when a user of the portable terminal intends to set a schedule according to FIG. 4A or FIG. 4B, a schedule setting screen is output as illustrated in FIG. 4C. In this case, the portable terminal may set the schedule for one week including a date selected by the user of the portable terminal In addition, the user of the portable terminal may set the schedule of the date by moving a schedule setting bar 409 (i.e., a schedule setting start bar and a schedule setting end bar). That is, the portable terminal may perform fast and simple schedule setting by moving the bar while omitting an input process of schedule setting start and end times.

FIG. 4D illustrates a screen displayed after schedule setting is complete in a portable terminal according to an exemplary embodiment of the present invention.

The screen of FIG. 4D is for setting a schedule by using the schedule setting bar of FIG. 4C. Herein, a specific time which is set by using the schedule setting bar is dragged onto a schedule setting icon to set a schedule on a specific time.

In FIG. 4D, a user sets a schedule on Jul. 20, 2008 from 17:00 to 21:00 (indicated by 411), Jul. 22, 2008 from 09:00 to 15:00 (indicated by 413), and Jul. 26, 2008 from 17:00 to 23:00 (indicated by 415).

In this case, the portable terminal also outputs a schedule setting icon that indicates a schedule type to show which schedule is set on a corresponding date.

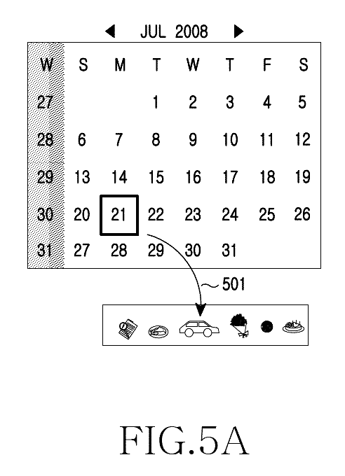

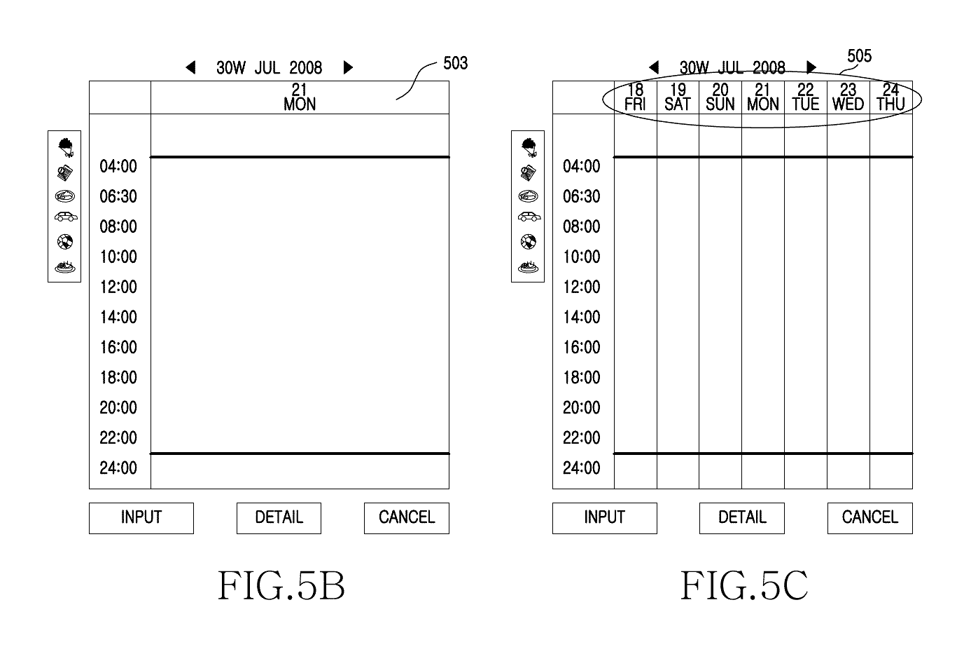

FIGS. 5A-5C illustrate a schedule setting screen of a portable terminal according to an exemplary embodiment of the present invention. The schedule setting screen of FIGS. 5A-5C will be described below by using the schedule setting screen of FIGS. 4A-4D, for example.

FIG. 5A illustrates a screen for setting a schedule by dragging a date for which the schedule is to be set in a portable terminal according to an exemplary embodiment of the present invention.

Referring to FIG. 5A, a user of the portable terminal intends to set a schedule for a journey on Jul. 21, 2008, and drags the date of the 21^{st} (indicated by 501) onto a schedule setting icon that indicates a journey.

FIG. 5B illustrates a screen for setting a schedule by using a drag mechanism in a portable terminal according to an exemplary embodiment of the present invention.

Referring to FIG. 5B, when a user of the portable terminal intends to set a schedule by using the screen of FIG. 5A, a schedule setting screen is output as illustrated in FIG. 5B. In this case, the portable terminal may set a schedule only on a corresponding date 503, which differs from FIG. 5C to be described below. That is, when the user of the portable terminal intends to set a schedule on the date of the 21^{st}, the portable terminal provides a schedule setting range corresponding to the date of the 21^{st}.

FIG. 5C illustrates a screen for setting a schedule by using a drag mechanism in a portable terminal according to an exemplary embodiment of the present invention.

Referring to FIG. 5C, when a user of the portable terminal intends to set a schedule by using the screen of FIG. 5A, a schedule setting screen is output as illustrated in FIG. 5C. In this case, the portable terminal may set a schedule on dates (indicated by 505) before or after a date selected by the user of the portable terminal. That is, if the user of the portable terminal intends to set a schedule on the date of the 21^{st}, the portable terminal provides a schedule setting range from a date of the 18^{th} to a date of the 24^{th}. A detailed item may be input through the schedule setting screen according to a user's choice.

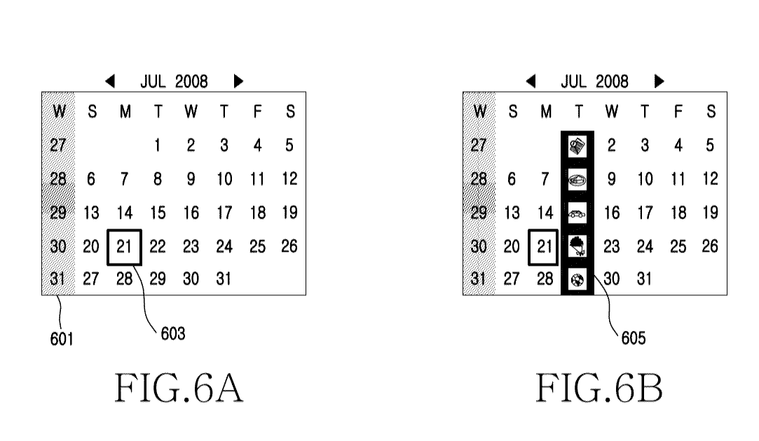

FIGS. 6A-6B illustrate a schedule setting process of a portable terminal according to an exemplary embodiment of the present invention.

In an exemplary implementation, the portable terminal provides a schedule setting icon capable of setting a schedule on a corresponding date by clicking the date, instead of performing a conventional schedule setting in a portable terminal through a plurality of menu inputs. Therefore, the present invention may provide a simpler schedule setting process than the conventional schedule setting process.

FIG. 6A illustrates a screen for clicking or touching a date for which a schedule is to be set in a portable terminal according to an exemplary embodiment of the present invention.

Referring to FIG. 6A, a user of the portable terminal intends to set a schedule on Jul. 21, 2008 on a calendar 601, and performs schedule setting by clicking or touching a corresponding date 603 (i.e., the date of the 21^{st}).

FIG. 6B illustrates a screen showing a schedule setting icon used to set a schedule on a date in a portable terminal according to an exemplary embodiment of the present invention.

When a user of the portable terminal clicks or touches a specific date for which a schedule is to be set, the portable terminal outputs a schedule setting icon as indicated by 605 to set the schedule on the specific date.

Accordingly, the user of the portable terminal may set the schedule by using the schedule setting icon on the specific date.

As described above, exemplary embodiments of the present invention relate to an apparatus and method for fast schedule setting in which a schedule is set by dragging a schedule setting icon or a date for schedule setting. Therefore, the exemplary embodiments of the present invention provide user convenience by setting a schedule simpler and faster, instead of setting a schedule through a plurality of key inputs.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for schedule setting in a portable terminal, the apparatus comprising:
a touch manager for determining whether a drag execution is performed for schedule setting by a schedule type;
a controller for performing the schedule setting on a date selected for schedule setting; and
a schedule setting unit for setting a schedule when the touch manager detects overlapping of the date with a schedule setting icon.

2. The apparatus of claim 1, wherein the drag execution for schedule setting comprises at least one of a drag for moving the date to the schedule setting icon and a drag for moving the schedule setting icon to the date.

3. The apparatus of claim 2, wherein, under control of the controller, the schedule setting unit outputs the schedule setting screen when the touch manager detects the drag execution.

4. The apparatus of claim 1, wherein the schedule setting screen comprises a schedule setting bar for setting a schedule setting time.

5. The apparatus of claim 4, wherein the schedule setting bar comprises a schedule setting start bar and a schedule setting end bar.

6. The apparatus of claim 1, wherein, when the touch manager detects at least one of a touch and a click on the date for schedule setting, the schedule setting unit outputs the schedule setting icon around the at least one of touched and clicked date.

7. The apparatus of claim 1, wherein the schedule setting icon is capable of being at least one of added and deleted by a user.

8. A method for schedule setting in a portable terminal, the method comprising:
Determining, by a touch manager, whether a drag execution is performed for schedule setting by a schedule type;
Performing, by a controller the schedule setting on a date for schedule setting; and
Setting, by a schedule setting unit, a schedule when the touch manager detects overlapping of the date with a schedule setting icon.

9. The method of claim 8, wherein the drag execution for schedule setting comprises at least one of a drag for moving the date to the schedule setting icon and a drag for moving the schedule setting icon to the date.

10. The method of claim 8, further comprising outputting a schedule setting screen upon detection of the drag execution.

11. The method of claim 10, wherein the schedule setting screen comprises a schedule setting bar for setting a schedule setting time.

12. The method of claim 11, wherein the schedule setting bar comprises a schedule setting start bar and a schedule setting end bar.

13. The method of claim 8, further comprising, upon detecting at least one of a touch and a click on the date for schedule setting, outputting the schedule setting icon around the at least one of touched date and clicked date.

14. The method of claim 8, wherein the schedule setting icon is capable of being at least one of added and deleted by a user.
